(19) United States
(12) Patent Application Publication
(10) Pub. No.: US 2003/0161505 A1
(43) Pub. Date: Aug. 28, 2003

(54) System and method for biometric data capture and comparison

(76) Inventor: Lawrence Schrank, Westminster, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/074,157

(22) Filed: Feb. 12, 2002

(51) Int. Cl. G06K 9/00

(52) U.S. Cl. 382/118

(57) ABSTRACT

A system and method for capturing 3D images of target objects and comparing the captured image against a database of stored images (3D and or 2D) is described. One embodiment includes an image collection device configured to collect a three-dimensional image record about a target object; a data reader configured to read a baseline three-dimensional image record from a data storage device; a comparator connected to the image collection device and the data reader, the comparator configured to compare the target object's three-dimensional image record with the baseline three-dimensional image record; and an output device connected to the comparator, the output device configured to generate an output responsive to the comparator matching the target object's three-dimensional image record with the baseline three-dimensional image record.

### FIELD OF THE INVENTION

The present invention relates to three-dimensional (3D) imaging. In particular, but not by way of limitation, the present invention relates to systems and methods for capturing 3D images of target objects and comparing the captured 3D image against a database of stored 2D or 3D images.

### BACKGROUND OF THE INVENTION

Three-dimensional imaging is well known in the graphic arts and computer sciences. Although a number of modeling techniques are available, the use of polygons to approximate objects and landscapes is the most prevalent. Polygon representations, however, even with techniques such as texture mapping, provide poor approximations of real world, and especially natural or organic, objects. Polygon representations are limited because of their faceted polygonal or “smooth” regularity. Real world forms, such as human faces, however, have certain imperfections and variances that cannot be properly represented by the straight edges of polygons. Even though polygons are inadequate for representing most real world objects, they are almost always used in real-time graphics systems because of their widespread implementation and low processor and memory requirements.

Volumetrics, or volume graphics, offer an alternative to polygon-based 3D graphics. Volume graphics are based on the volumetric pixel, called a “voxel,” which is a generalization of the notion of a pixel (or ‘picture element’) in 2D graphics. Rather than representing a portion of an image in an X and Y plane like the pixel, a voxel represents a portion of a volume in the X, Y, and Z plane. Each voxel is associated with a cubic unit of space and contains a value—generally a color. When a set of voxels are grouped together to represent an image, that group of voxels is called a voxel data set.

Volume graphics has inherent advantages for applications needing visualization of real-world objects, such as human faces. For example, the level of detail available through volume graphics is much higher than is available through polygon representations. Voxel data sets, however, require a great deal of memory to implement. In fact, voxel data sets require so much memory that they are rarely successfully used for real-time applications. To reduce the amount of memory required by voxel data sets, several methods of data compression have been developed, including volume buffers, octrees, and binary space-partitioning trees.

Generally, however, even these advanced methods of compressing voxel data sets have proven ineffective for real-time applications. Because image recognition systems must operate in real-time or near real-time, most identity recognition systems today are two-dimensional in that they compare 2D images (digital photographs). A few have begun to explore the possibility of using 3D geometry for identity recognition. They have, however, attempted to use polygon-based technology. In operation, these polygon-based 3D systems scan a person's face and model it based upon polygons. This is called a baseline image. The baseline image is then stored for subsequent retrieval and comparison in or near real-time against the image data for a newly scanned face. Because polygons so poorly represent the human face, polygon-based identity recognition systems frequently generate false matches and miss legitimate matches between a scanned face and a baseline image. Additionally, polygon-based identity recognition systems are easy to spoof through disguises and, more importantly, are somewhat ineffective if the face of the person being scanned is not at the same general angle as the baseline image.

Polygons are not completely satisfactory for real-world image recognition. In particular, polygons are not satisfactory for verifying the identity of people. Although volume graphics is best equipped to represent real-world images, the excessive memory requirements of volume graphics renders it generally unacceptable for real-time applications such as identity verification. Thus, identity verification systems that would otherwise benefit from image recognition, e.g., facial recognition, tend to use other biometric data such as voice, fingerprint, iris pattern, and handprint. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for real-time image matching using volume graphics. In one exemplary embodiment, the present invention can include a 3D image acquisition device (IAD), an image converter, a comparator, and an image database 120. In operation, the IAD scans an object, such as a human face, and passes that image data to a converter. The converter then converts the image data from its native format to a voxel-based format, such as the dual octree format described herein, and passes the voxel-based image data to the comparator.

After receiving the image data, the comparator identifies key characteristics of the scanned object and uses those characteristics to index images stored in the image database 120. The comparator then sorts through the baseline images stored in the image database 120 and determines whether any of the baseline images match the image of the scanned object. If a baseline image matches the image of the scanned object, then the comparator can generate a signal for an I/O device. The I/O device, in response, could merely display “APPROVED” or “DENIED,” or it could activate some mechanical process such as locking or unlocking a door. In other embodiments of the present invention, the I/O device could grant or deny access to a computer system such as a networked computer or an automated teller machine.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a block diagram of an image recognition system in accordance with the principles of the present invention;

FIG. 2 is a flowchart of one method for operating the system shown in FIG. 1;

FIG. 3 illustrates a block diagram of another embodiment of an image recognition system in accordance with the principles of the present invention;

FIG. 4 illustrates a block diagram of a distributed image recognition system in accordance with the principles of the present invention;

FIG. 5 is a flowchart of one method for comparing 3D image data with 2D image data in accordance with the principles of the present invention; and

FIG. 6 illustrates one system for collecting 3D image data in accordance with the principles of the present invention.

### DETAILED DESCRIPTION

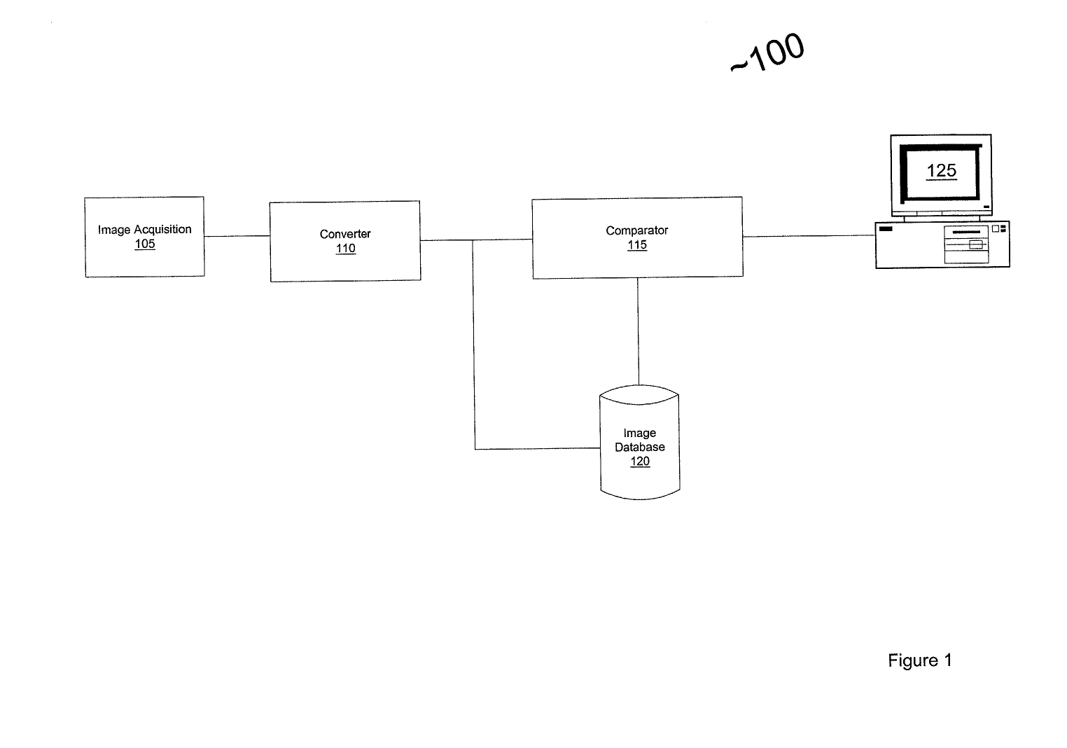

Referring now to the drawings, where like or similar elements are designated with identical reference numerals throughout the several views, and referring in particular to FIG. 1, it illustrates a block diagram of an image recognition system 100 in accordance with the principles of the present invention. This embodiment includes an IAD 105, a converter, a comparator 115, an image database 120, and an I/O device 125.

In operation, the IAD 105 collects image data about a 3D object (the target object) and passes that data to the converter. The IAD 105 can be of almost any type of imaging device, including a 3D laser scanner, structured light scanner, 3D camera, thermal imager, infrared imager, etc. Once the target object's image has been captured, the converter can convert the image data to a voxel-based format, which can reduce the size of the image data. As previously described, a “voxel” is a cubic element within a three dimensional volume. Several voxel-based formats are available and can be used with the present invention. Some of these formats include volume buffers, octrees, and binary space partitioning trees. Because some formats require more memory than others, the appropriate voxel-based format depends upon the amount of image data being captured. More sophisticated voxel-based formats include the dual octree.

The dual-octree format is based upon the standard octree, which is a derivative of the 2D quadtree. Although quadtrees and octrees are well known, a brief description is included for clarity. Quadtrees work by recursively dividing the area of a 2D image into four equal quadrants. Each of these four quadrants is then divided into another four quadrants. This recursive process continues until each quadrant contains a single cell type or a maximum tree depth is reached. All cells are of the same type if they contain pixels of identical color or if the cells are empty. Because each quadrant is linked to its parent quadrant and its four children quadrants, the entire image can be expressed in a tree format.

Octrees work in the same general manner as quadtrees except that each subdivision occurs in three dimensions and divides the space into octants rather than quadrants. Each octant is subdivided until each octant contains a single type of cell. Similar to the quadtrees, the entire volume can be expressed in a tree format wherein each octant is linked to its parent octant and its eight children octants. Octrees provide a great deal of compression because the majority of volumes contain large areas of blank or identical space that need not be fully represented in the tree because if a parent octant's value is “empty,” then the value of all of its children is also “empty.”

Although the octree provides a great deal of compression of voxel data sets, the dual octree provides even more compression. The dual octree uses the standard octree representation of an object to generate a second octree, wherein the second octree represents only the portion of the object that is visible from a particular reference point. In essence, the dual octree hides the non-visible portions of the object as seen from a particular reference point. One version of the dual octree is described in U.S. Pat. No. 5,123,084, entitled Method for the 3D Display of Octree-encoded Objects and Device for the Application of this Method, which is incorporated herein by reference.

Referring again to FIG. 1, the converter is shown to be separated from the IAD 105. Other embodiments, however, include an integrated IAD 105 and converter such that the output of the IAD 105 is in a voxel-based format. In yet other embodiments, the IAD 105 originally captures the image data in a voxel-based format. The IAD 105 can output this native voxel-based format or can convert it to another voxel-based format.

After the image data for the target object has been acquired and placed in the proper format, the comparator 115 can compare the target object's image data with stored image data. In essence the comparator 115 attempts to match the scanned image with an image stored in the image database 120. One such comparator 115 is based on technology offered by Roz Software Systems (4417 N. Saddlebag Tr. #3, Scottsdale, Ariz. 85251).

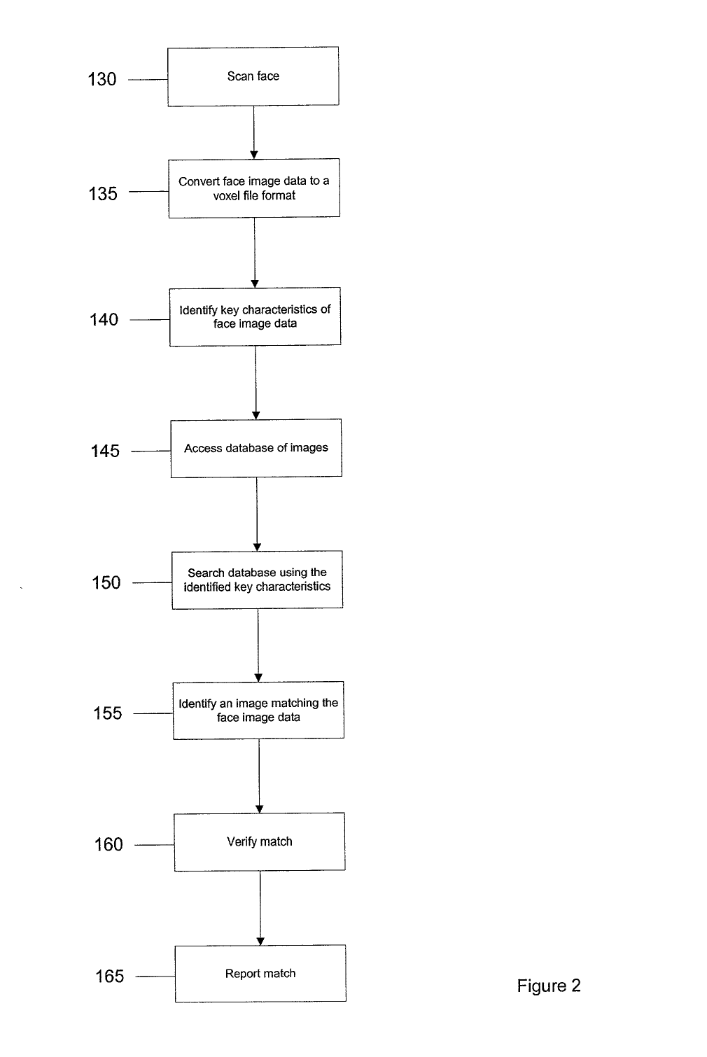

FIG. 2 is a flowchart of one method of operating the system of FIG. 1. This method is directed toward facial recognition, but can easily be adapted for other 3D objects. Initially, the IAD 105 scans the target's face (step 130). As previously described, typical devices used for scanning (or ‘capturing’ a 3D target objects geometry) include laser scanners, structured-light scanners, photogrammetric cameras and 3D cameras, etc. The data captured in the scanning or capture process is not limited to 3D geometry but can include many other data variables including color, texture, and even temperature (thermal imaging). Regardless of which type of IAD 105 is used, when necessary, the captured data is converted to a voxel-based format, such as a dual octree format (step 135).

Using the voxel-based format of the image data, the comparator 115 can search a database of stored images and locate any matches. In one embodiment of the present invention, the comparator 115 first identifies key characteristics of the target's face as reflected in the image data (step 140). Examples of characteristics that the comparator 115 can consider include 3D distance (e.g., interpupilary distance), 3D shape, texture, color, surface information, etc. The comparator 115 can then use these key characteristics to index the database of stored images and identify a group of images that possibly match the scanned face (steps 145, 150, and 155). Assuming that the group of images includes more than one possible matching image, the comparator 115 identifies a set of secondary characteristics associated with the scanned face and filters the group of images with those secondary characteristics. Once the comparator 115 has determined a possible match, it can verify and report its findings (steps 160 and 165). In one embodiment, thermal images are captured and compared against images captured by the IAD 105 to prevent prosthetic devices or other feature-altering devices from generating false results in the comparator 115.

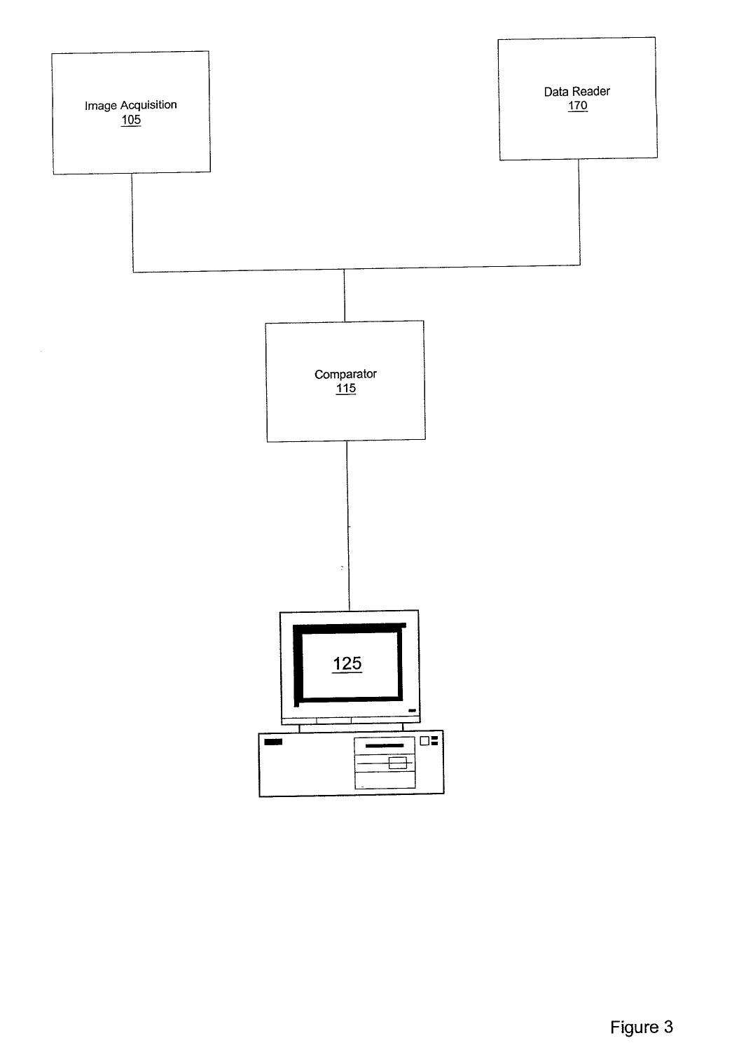

Referring now to FIG. 3, it illustrates an alternate embodiment of the present invention. In this embodiment, the comparator 115 is connected to an IAD 105, a data reader 170 and an I/O device 125. As with the system shown in FIG. 2, the IAD 105 collects image data about a target object and passes that data to the comparator 115. Instead of comparing the target's image data against a group of images stored in a database, however, this embodiment of the present invention, compares the received image data against image data read from the data reader 170. For example, the data reader 170 could be a smart card reader and could read 3D image data from the smart card.

In an identity verification system, for example, a user could insert a smart card encoded with the voxel representation of the user's 3D image—and other biometric data—into the card reader. The card reader can then read the image data from the smart card and forward that data to the comparator 115. At approximately the same time, the IAD 105 can scan the user and pass that image data to the comparator 115. The comparator 115 can then determine if the scanned image data and the image on the smart card match. If the data matches, the I/O device can be notified and an appropriate action, such as unlocking a door, can be initiated. Although not shown in FIG. 3, a converter as shown in FIG. 1 can be included. Alternatively, the IAD 105 can output the image data in the required voxel-based format.

Embodiments of the present invention can work with most any smart card technology. Examples of such smart card technology are produced by UltraCard, Inc. (980 University Ave., Los Gatos, Calif. 95032). In addition to smart cards, embodiments of the present invention can use secure microcontrollers and other storage devices that communicate with the data reader 170 through electrical contact, infra-red transmissions, or radio frequency transmissions.

For security, the image data stored on a smart card can be encrypted or associated with a digital signature that prevents tampering. Additionally, the smart card and card reader could include features to prevent playback or other security attacks. These types of security features are well known in the art and are not described in detail herein.

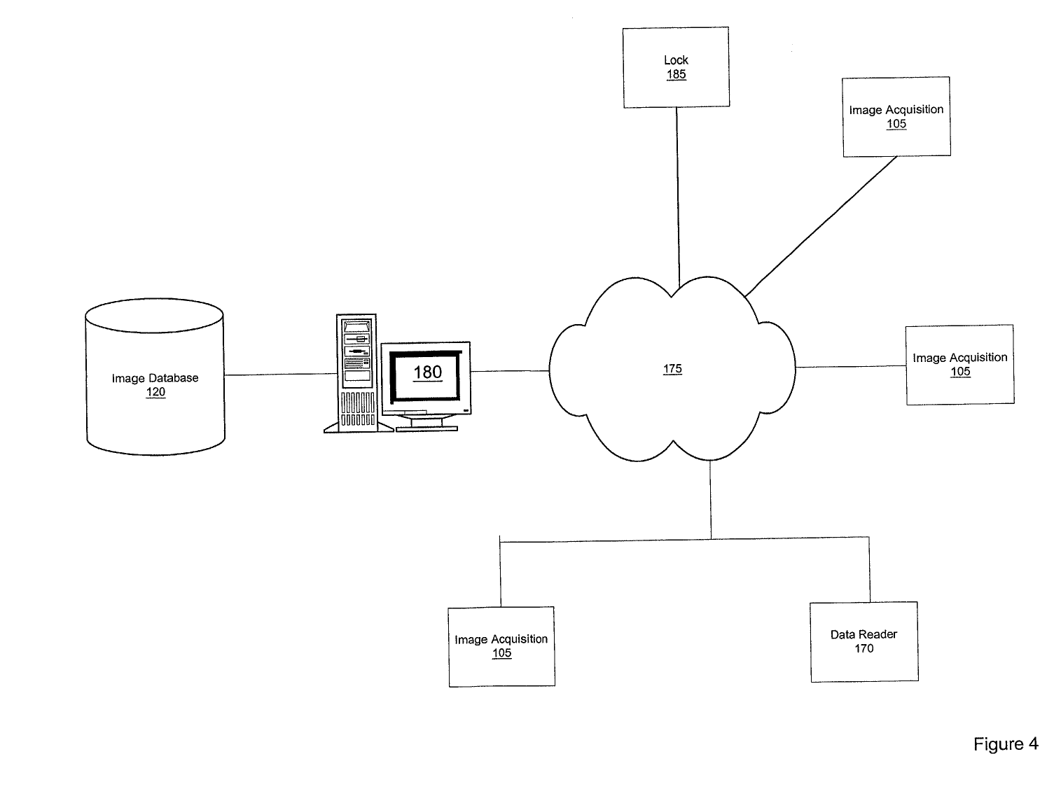

Referring now to FIG. 4, it illustrates a distributed embodiment of the present invention. In this embodiment, IADs 105 and data readers 170 are connected through a network 175 to an image server 180. The image server can include the comparator 115 of FIG. 1 as well as other components. For example, the image server 180 can collect 3D image data from the IADs 105 and compare that data with image data stored on the image database 120. The image data transmitted from the IADs 105 to the image server 180 can be transported by the network 175, which can be a private network or a public network such as the Internet. If necessary, encryption or other security protocols can be used to protect the integrity of the image data being transported over the network 175.

When the image data acquired by the IAD 105 matches an image in the image database 120, the image server can transmit an appropriate, possibly secure, signal to a device attached to the network. For example, the image server could generate a signal that activates or deactivates a lock 185. Alternatively, the image server could generate a signal that would allow access to a computer system.

The system shown in FIG. 4 also includes a data reader and a connected IAD 105. Although the IAD 105 and data reader can operate as a stand-alone system, they can also be attached to the network 175. In this embodiment, the image data collected by the data reader could be sent to the image server 180 for comparison. Thus, the comparison functions would be centralized at the image server 180 rather than distributed to each data reader-IAD pair.

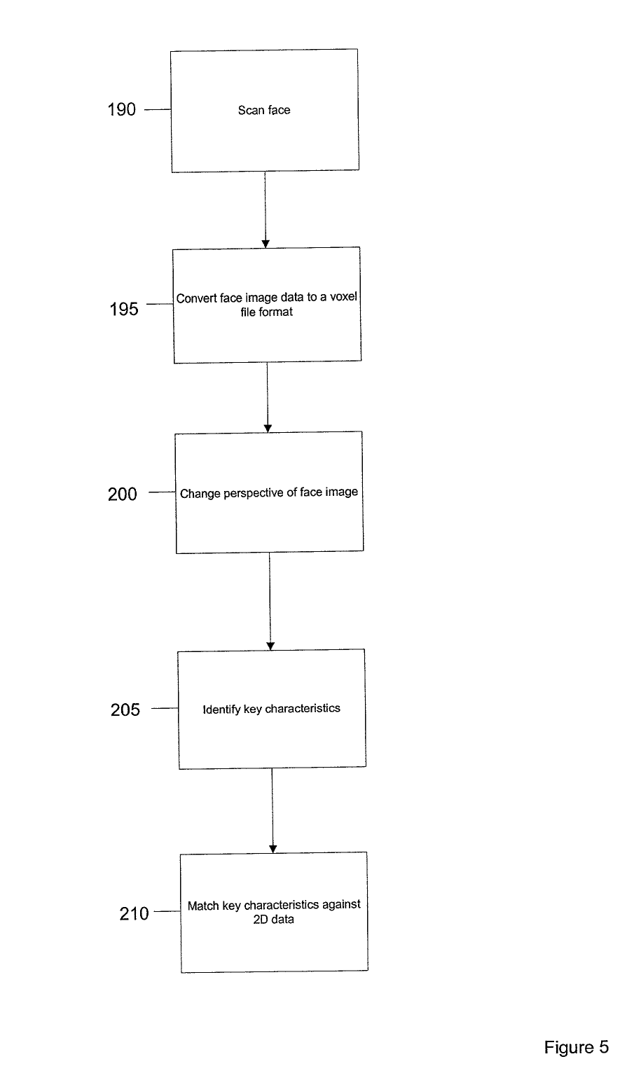

Referring now to FIG. 5, it is a flowchart of one method for comparing 3D image data with 2D image data. In this embodiment of the invention, an IAD 105 initially scans an object, such as a face, and converts that data into a voxel-based format (steps 190 and 195). This image data is then passed to the comparator 115, and the comparator 115 determines that it is comparing 3D data with 2D data. The comparator 115 then electronically rotates the perspective, i.e., viewing angle of the scanned object to match the perspective of the 2D image (step 200). For example, assume that the original 3D data for a person's face was from a front perspective and that the 2D data was collected from a left-side perspective. The comparator 115 could rotate the 3D data so that it provides a left-side perspective and match this rotated image data against the 2D image data. Once the perspectives of the 3D data and the 2D data have been matched, the comparison of the images is similar to the steps described for FIG. 2. For example, the comparator 115 can identify key characteristics of the scanned image and compare those characteristics against the characteristics of the 2D image (step 205 and 210). In another embodiment of the present invention, key characteristics of the 2D image can be matched against a database of 3D images. For example, a 2D picture of a person could be compared against a database of 3D images of known persons.

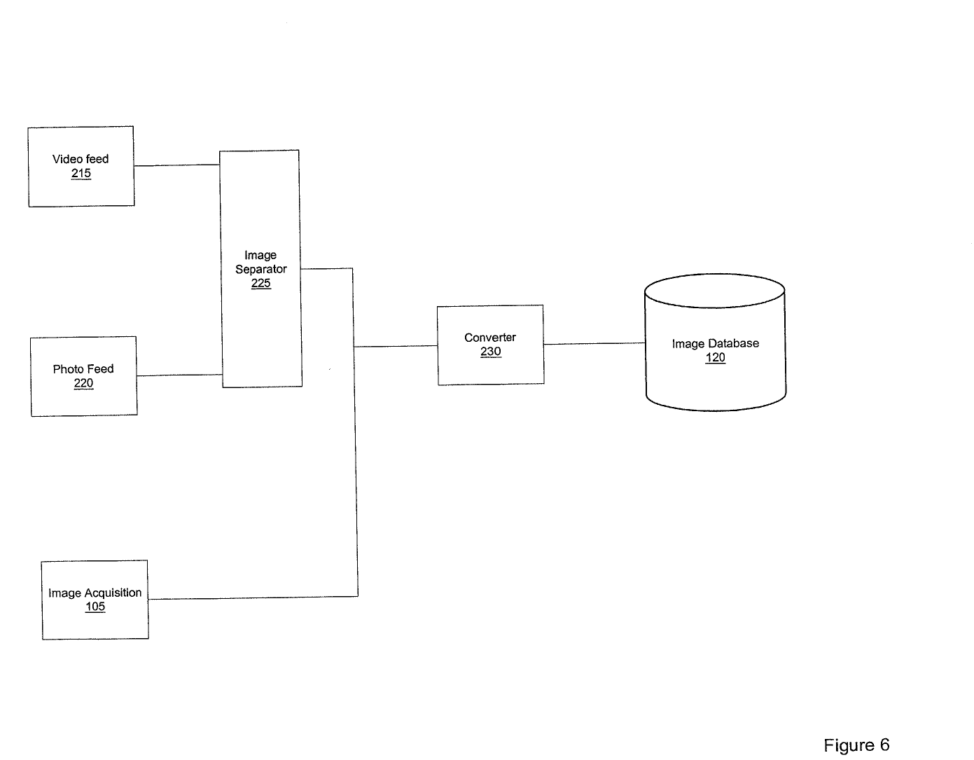

Referring now to FIG. 6, it illustrates one system for collecting 3D image data. In this embodiment, image data can be collected from three sources: video feed 215, photo feed 220, and IAD 105. The IAD 105 has been previously described and is not described again. The video feed 215 and the photo feed 220, however, are described below.

The video feed 215 and the photo feed 220 differ from the IAD 105 in that they capture 2D images. The video feed 215, for example, allows image data from live and recorded footage to be collected and passed to the image separator 225. The image separator 225 selects individual frames and isolates objects, e.g., people, within those frames. The isolated object's image data is then passed to the converter 230 where it is placed in the proper 2D format. The image data can then be stored on the image database 120. The image separator 225 can isolate other objects within the selected frame or, if there are no unprocessed objects, advance the frame. When analyzing subsequent frames, the image separator 225, or some other component, can screen out objects whose images have previously been stored. The photo feed 220 is similar to the video feed 215. In concept, the photo feed 220 is processing a single frame of a video.

In conclusion, the present invention provides, among other things, a system and method for capturing 3D images of target objects and comparing the captured image against a database of stored images. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for verifying the identity of a target object, the method comprising:
collecting a three-dimensional image record for a target object, wherein the collected image record is in a native format;
converting the three dimensional image record to a dual-octree-format voxel data set;
identifying a target-object-characteristic reflected in the voxel data set; and
locating a matching image record in a plurality of stored image records, wherein the matching image record includes a characteristic matching the identified target-object characteristic.

2. The method of claim 1, wherein collecting a three-dimensional image record comprises:
scanning a face.

3. The method of claim I, further comprising:
transferring the collected three-dimensional image record over a network.

4. The method of claim 1, wherein collecting a three-dimensional image record comprises:
reading the three-dimensional image record from a data storage device.

5. The method of claim 4, wherein reading the three-dimensional image record from a data storage device comprises:
reading the three dimensional image record from a smart card.

6. The method of claim 1, further comprising:
collecting thermal data about the target object.

7. The method of claim 6, further comprising:
matching the thermal data with the collected image record.

8. A system for verifying the identity of a target object, the system comprising:
an image collection device configured to output an image record for the target object in a native format;
a data converter connected to the image collection device, the data converter configured to convert the image record from the native format to a voxel-based format;
a comparator connected to the data converter, the comparator configured to compare the voxel-based format of the image record against a stored voxel-based image record; and
an output device connected to the comparator, the output device configured to generate an output responsive to the comparator matching the voxel-based format of the image record against the stored voxel-based image record.

9. The system of claim 8, wherein the image collection device comprises:
a three-dimensional laser scanner.

10. The system of claim 8, wherein the data converter is configured to convert the image record from the native format to a dual octree format.

11. The system of claim 8, wherein the image collection device comprises:
a thermal imaging device.

12. A system for verifying the identity of a target object, the system comprising:
an image collection device configured to output a three dimensional image record for the target object in a dual octree format;
a comparator connected to the image collection device, the comparator configured to compare the dual octree format of the image record against a stored dual octree image record; and
an output device connected to the comparator, the output device configured to generate an output responsive to the comparator matching the dual octree format of the image record against the stored dual octree image record.

13. The system of claim 12, wherein the image collection device comprises:
a thermal imaging device.

14. A system for verifying the identity of a target object, the system comprising:
an image collection device configured to collect a three-dimensional image record descriptive of a target object;
a data reader configured to read a baseline three-dimensional image record from a data storage device;
a comparator connected to the image collection device and the data reader, the comparator configured to compare the three-dimensional image record of the target object with the baseline three-dimensional image record; and
an output device connected to the comparator, the output device configured to generate an output responsive to the comparator matching the three-dimensional image record of the target object with the baseline three-dimensional image record.

15. The system of claim 14, wherein the data reader comprises:
a smart card reader.

16. The system of claim 14, wherein the baseline three-dimensional image record comprises:
a voxel data set.

17. The system of claim 14, wherein the baseline three-dimensional image record comprises:
a dual octree.

18. A system for verifying the identity of a target object, the system comprising:
a data reader configured to read a baseline three-dimensional image record from a data storage device;
a comparator connected to the data reader and connectable to a image collection device, the comparator configured to compare a three-dimensional image record collected by the image collection device with the baseline three-dimensional image record; and
an output device connected to the comparator, the output device configured to generate an output responsive to the comparator matching the target object's three-dimensional image record with the baseline three-dimensional image record.

19. The system of claim 18, wherein the baseline three-dimensional image record comprises:
a voxel data set.

20. The system of claim 18, wherein the baseline three-dimensional image record comprises:
a dual octree.

21. A method for verifying the identity of a target object, the method comprising:
receiving a three-dimensional image record for a target object, wherein the three-dimensional image record comprises a voxel data set;
identifying a first target object characteristic reflected in the image record; and
locating a matching image record in a plurality of stored image records, wherein the matching image record includes an object characteristic matching the identified first target object characteristic.

22. The method of claim 21, wherein the voxel data set is arranged in a dual octree format.

23. The method of claim 21, further comprising:
receiving a thermal image record for the target object; and
matching the thermal image record with the three-dimensional record.
